(19) United States
(12) Patent Application Publication
(10) Pub. No.: US 2011/0161109 A1
(43) Pub. Date: Jun. 30, 2011

(54) SYSTEMS AND METHODS FOR PROVIDING ADHERENCE-BASED MESSAGES AND BENEFITS

(75) Inventors: Roger Pinsonneault, Alpharetta, GA (US); Brian Bertha, Danville, CA (US)

(73) Assignee: MCKESSON FINANCIAL HOLDINGS LIMITED, Hamilton (BM)

(21) Appl. No.: 12/650,759

(22) Filed: Dec. 31, 2009

(51) Int. Cl. G06Q 50/00; G06Q 10/00; G06Q 30/00

(52) U.S. Cl. 705/3; 705/2

(57) ABSTRACT

Systems and methods may include receiving, from a healthcare provider computer, a first healthcare transaction that identifies a product to be dispensed, and a patient for receiving the product, the first healthcare transaction associated with a first date; determining that the product is associated with an adherence monitoring program; storing an association between the patient, the product to be dispensed, and the first date associated with the first healthcare transaction; receiving, from a healthcare provider computer, a second healthcare transaction that identifies the product to be dispensed, and the patient for receiving the product, the second healthcare transaction associated with a second date; determining a level of adherence to the patient specifications of the adherence monitoring program by comparing at least the second date associated with the second healthcare transaction to the first date associated with the first healthcare transaction; and delivering or directing a delivery of an adherence message that indicates the determined level of adherence to the patient specifications of the adherence monitoring program.

### FIELD OF THE INVENTION

Aspects of the invention relate generally to healthcare transactions, and more particularly, to providing adherence-based messages and benefits based upon evaluations of healthcare transactions.

### BACKGROUND OF THE INVENTION

Medication Therapy Management (MTM) and other medication adherence programs involve a partnership of the pharmacists, the patients or their caregivers, and other healthcare providers that promotes the safe and effective use of medications and helps patients achieve the targeted outcomes from medication therapy. Further, it has been demonstrated that Medication Therapy Management and other medication adherence programs can lead to a reduction of healthcare expenditures by patient, and likewise, an insurer of the patient. However, the effectiveness of Medication Therapy Management or other medication adherence programs depends on the patient utilizing the medication in an adherent manner. Thus, there is a need in the industry for systems and methods for providing adherence-based messages and benefits.

### SUMMARY OF THE INVENTION

Some or all of the above needs and/or problems may be addressed by certain embodiments of the invention. Embodiments of the invention may include systems and methods for providing adherence-based messages and benefits. In one embodiment, there is a computer-implemented method. The method may include receiving, from a healthcare provider computer, a first healthcare transaction that identifies a product to be dispensed, and a patient for receiving the product, the first healthcare transaction associated with a first date; determining that the product is associated with an adherence monitoring program, the adherence monitoring program indicating patient specifications for patient utilization of the product; storing, based at least in part upon the determination that the patient is associated with an adherence monitoring program, an association between the patient, the product to be dispensed, and the first date associated with the first healthcare transaction; receiving, from a healthcare provider computer, a second healthcare transaction that identifies the product to be dispensed, and the patient for receiving the product, the second healthcare transaction received subsequent to receiving the first healthcare transaction, the second healthcare transaction associated with a second date; determining a level of adherence to the patient specifications of the adherence monitoring program by comparing at least the second date associated with the second healthcare transaction to the first date associated with the first healthcare transaction; and delivering or directing a delivery of an adherence message that indicates the determined level of adherence to the patient specifications of the adherence monitoring program. The prior steps may be performed by one or more service provider computer systems comprising one or more computers.

According to another example embodiment, there is a system. The system may include at least one memory operable to store computer-executable instructions, and at least one processor configured to access the at least one memory. The at least one processor may be configured to execute the computer-executable instructions to: receive, from a healthcare provider computer, a first healthcare transaction that identifies a product to be dispensed, and a patient for receiving the product, the first healthcare transaction associated with a first date; determine that the product is associated with an adherence monitoring program, the adherence monitoring program indicating patient specifications for patient utilization of the product; store, based at least in part upon the determination that the patient is associated with an adherence monitoring program, an association between the patient, the product to be dispensed, and the first date associated with the first healthcare transaction; receive, from a healthcare provider computer, a second healthcare transaction that identifies the product to be dispensed, and the patient for receiving the product, the second healthcare transaction received subsequent to receiving the first healthcare transaction, the second healthcare transaction associated with a second date; determine a level of adherence to the patient specifications of the adherence monitoring program by comparing at least the second date associated with the second healthcare transaction to the first date associated with the first healthcare transaction, and deliver or direct a delivery of an adherence message that indicates the determined level of adherence to the patient specifications of the adherence monitoring program.

Additional systems, methods, apparatus, features, and aspects may be realized though the techniques of various embodiments of the invention. Other embodiments and aspects of the invention are described in detail herein with reference to the description and to the drawings and are considered a part of the claimed invention.

### BRIEF DESCRIPTION OF THE DRAWINGS

Reference will now be made to the accompanying drawings, which are not necessarily drawn to scale, and wherein:

FIG. 1 illustrates an example healthcare system 100 that supports adherence-based monitoring, messaging, and benefits processing, according to an example embodiment of the invention.

FIGS. 2A-2B are block diagrams representing example data flows of systems that may support adherence-based monitoring, messaging, and benefits processing, according to example embodiments of the invention.

FIG. 3 illustrates an overview of an example method for performing adherence-based monitoring, messaging, and benefits processing, according to example embodiments of the invention.

FIG. 4 illustrates an example method for capturing transaction information for patient in accordance with an adherence monitoring program when a relevant product is dispensed to a patient, according to an example embodiment of the invention.

FIG. 5 illustrates an example method for adherence-based monitoring, messaging, and benefits processing in response to another healthcare transaction, according to an example embodiment of the invention.

FIG. 6 illustrates an example method for receiving updated prior transaction information from a healthcare provider (or a patient or other third party), according to an example embodiment of the invention.

### DETAILED DESCRIPTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention provide systems and methods for providing adherence messages and benefits based upon evaluations of healthcare transactions of the patient to determine or track therapy adherence by a patient. A service provider that is operable to route, send, or otherwise communicate healthcare transactions between healthcare providers and claims processors can provide systems operable to monitor healthcare transactions for a patient, and determine adherent behavior or non-adherent behavior. In an example embodiment of the invention, adherent behavior or non-adherent behavior may be based on whether a patient has refilled a product within an acceptable time frame according to an example embodiment of the invention. The service provider can also provide adherence messages and benefits, including financial benefits, based upon adherent behavior (e.g., acceptable time frame for a refilled product) by the patient.

The service provider is uniquely positioned to provide these adherence-based monitoring, messaging, and benefits features due to its unique operational relationship with multiple healthcare providers, such as pharmacies, hospitals, and/or physicians' offices, and multiple claims processors, such as third-party payors (e.g., insurance companies), as any relationships with other service providers. Therefore, a service provider, either alone or in conjunction with other service providers, can process a large percentage of healthcare transactions, and transact between a majority of the different healthcare providers and claims processors. Thus, a service provider of this type is advantageously positioned to capture and store information associated with patient healthcare transactions and to provide a complete or virtually complete transaction history for that patient. In addition, because most healthcare transactions are processed by a single service provider, the service provider is also well-positioned to supplement the typical transaction processing (e.g., pre-adjudication and/or post-adjudication processing, etc.) with adherence-based monitoring, messaging, and benefits processing, creating a value-add for the pharmacies, the drug manufacturers, the patients, the service provider, and/or related programs such as Medication Therapy Management (MTM) programs or similar product adherence programs. Moreover, by processing such a large volume of healthcare transactions, the service provider can advantageously monitor and evaluate healthcare transactions for patient to determine adherent behavior in order to provide for adherent-based messages and financial benefits, for example, when a patient has refilled a product in an acceptable time frame.

According to one embodiment, as described in more detail herein, the service provider may receive a first healthcare transaction (e.g., a billing request) for a prescription fill or refill from a healthcare provider (e.g., from a pharmacy) and route the received first healthcare transaction to an appropriate claims processor. Among other typical data elements, the first healthcare transaction includes at least an identity of the product to be dispensed to the patient and an identity of the patient. Upon receipt of the healthcare transaction (either before, simultaneously while, or after performing adjudication processing with a claims processor), the service provider can analyze the identity of the patient to determine whether the patient is associated with an adherence monitoring program for the product of the healthcare transaction. As used herein, the term “product” generally indicates any medication, drug, service, or other product that may be utilized by a patient as described herein, and is not intended to be limited to a specific product or product type.

Upon determining that the patient is associated with an adherence monitoring program, the service provider can store or update a transaction record with information included with or associated with the healthcare transaction. The information from the stored in the transaction record can depend on the type of adherence to be monitored by the adherence monitored program. Example types of adherence monitoring may comprise refill-type adherence monitoring, concomitant-therapy type adherence monitoring, and the like. As an example, for refill-type adherence monitoring, the transaction record may store an association between the patient, the product to be dispensed, a date associated with the first healthcare transaction, and a next refill date. The next refill date can be used to determine at least a first adherent time period in which a refill would be adherent or optimal, and a second non-adherent time period in which a refill would not be adherent or would be suboptimal. As an example, the first adherent time period may be on or prior to the next refill date while the second non-adherent time period may be subsequent to the next refill date. In an example embodiment of the invention, the next refill date can be determined from the days supply and/or quantity dispensed from the healthcare transaction. As an alternative to determining and storing the next refill date, the transaction record can alternatively or additionally store the days supply and/or dispense quantity indicated by the first healthcare transaction. As another example, for concomitant-therapy type adherence monitoring, the transaction record may store similar information as for the refill-type adherence, but also include one or more product classification types that may be needed to subsequently determine whether the patient is utilizing two or more products or product types in accordance with the adherence monitoring program.

Therefore, according to this example method, during a first healthcare transaction related to the fill or refill of a product for a patient, the service provider is able to capture and store the corresponding transaction record for the first healthcare transaction. Having the transaction record stored allows the service provider to access the stored information at a later time upon receipt of a second healthcare transaction (e.g., a request for a fill, refill, etc.) for the same product for the same patient to determine a level of adherence to the adherence monitoring program. An adherence message that indicates that determined level of adherence can be transmitted to the healthcare provider (e.g., to the pharmacy as one response to the new healthcare transaction, fax, printer, etc.), or to the patient (e.g., email or Internet message, cellular text message, fax, etc.). In addition, the service provider can also provide benefits, including financial benefits, based upon an acceptable level of adherence (e.g., product filled or refilled within an acceptable period of time from the prior fill or refill, verification of concomitant therapy, etc.), thereby providing an incentive for the patient to maintain or achieve the acceptable level of adherence.

As used herein, the term “patient” may refer to any consumer, such as, but not limited to, a recipient of prescription products, a patient of a physician, a purchaser of over-the-counter products, and the like.

System Overview

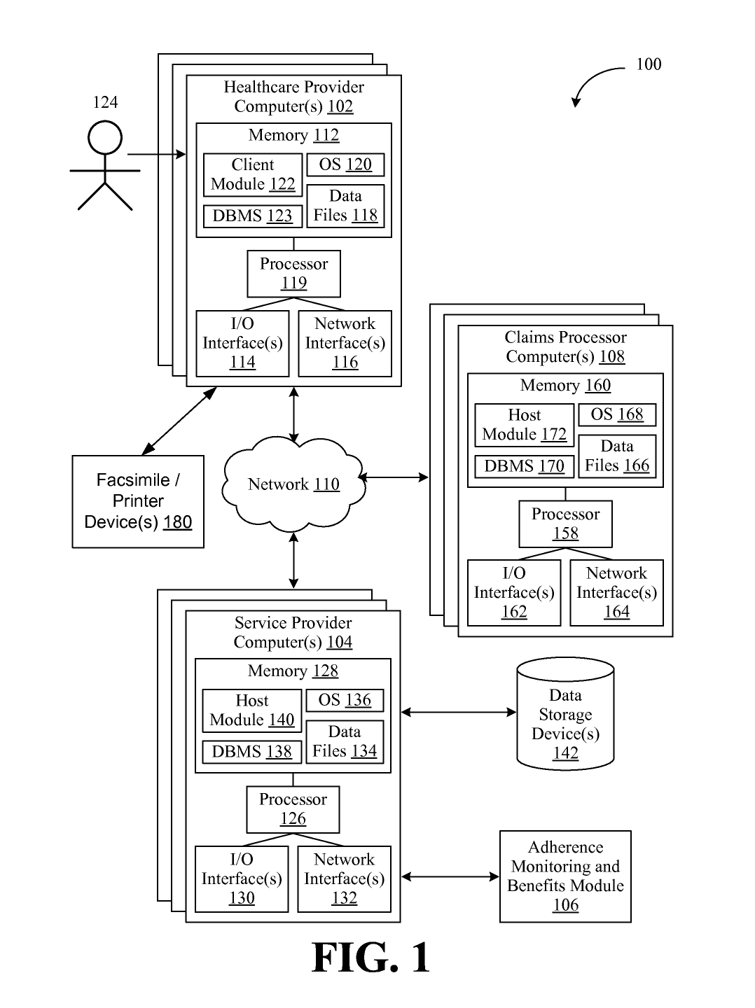

FIG. 1 illustrates an example healthcare system 100 that supports adherence-based monitoring, messaging, and benefits processing, according to an example embodiment of the invention. The system 100 may include at least one healthcare provider computer 102, at least one service provider computer 104, and at least one claims processor computer 108, each configured for accessing and reading associated computer-readable media having stored thereon data and/or computer-executable instructions for implementing the various methods described herein. Each of the healthcare provider computer 102, the service provider computer 104, and the claims processor computer 108 may be in direct communication with each other and/or in communication via a network 110, which as described below can include one or more private and public networks, including the Internet.

Although various computers are illustrated in, and described with reference to, FIG. 1, it is appreciated that each of these computers is associated with a respective entity. For example, a healthcare provider computer 102 is associated with and/or operated by a healthcare provider (e.g., a pharmacy or a physician's office), a service provider computer 104 is associated with and/or operated by a service provider, and a claims processor computer 108 is associated with a third-party claims processor (e.g., insurance payor, etc.). Moreover, multiple entities of the same type may participate, each associated with and/or operating one or more computers. For example, multiple healthcare providers and claims processors may participate in these processes, each associated with and/or operating one or more respective computers. Similarly, for each of the computers described herein, it is appreciated that various components and features of each of the computers may also be provided in multiples (e.g., multiple processors, memory elements, application modules, etc.), but may be referred to herein in the singular for simplicity.

The healthcare provider computer 102, the service provider computer 104, and the claims processor computer 108 may each be one or more processor-driven devices, such as, but not limited to, a server computer, a personal computer, a laptop computer, a handheld computer, and the like. In addition to having one or more processors 119, 126, 158, the healthcare provider computer 102, the service provider computer 104, and the claims processor computer 108 may each further include one or more memories 112, 128, 160, one or more input/output (“I/O”) interfaces 114, 130, 162, and one or more network interfaces 116, 132, 164, respectively. The memories 112, 128, 160 may store data files 118, 134, 166 and various program modules, such as an operating system (“OS”) 121, 136, 168, a client and/or host module 122, 140, 172, and a database management system (“DBMS”) 123, 138, 170 for accessing one or more databases, respectively. The I/O interface(s) 114, 130, 162 may facilitate communication between the processors 119, 126, 158, respectively, and various I/O devices, such as a keyboard, mouse, printer, microphone, speaker, monitor, bar code reader/scanner, RFID reader, and the like. The network interfaces 116, 132, 164 each may take any of a number of forms, such as a network interface card, a modem, a wireless network card, and the like.

With reference to the healthcare provider computer 102, the client module 122 may be an Internet browser or other software, such as a dedicated program, for interacting with the service provider computer 104. For example, a user 124, such as, but not limited to, a pharmacist, other pharmacy employee, physician, nurse, administrator, or a patient, may utilize the client module 122 in preparing and providing a healthcare transaction or order to the service provider computer 104 for processing and/or routing. In another example, a prescriber (e.g., physician or physician's office) may interface directly with the pharmacy and/or the healthcare provider computer 102, such as through written, electronic, or oral communications, or through the user 124, such as when providing the user a prescription to be presented to a pharmacy for filling. The client module 122 may also be utilized to retrieve or otherwise receive data from the service provider computer 104, including receiving adherence messages that indicates a level of adherence to the adherence monitoring program, as described herein.

According to one embodiment, the healthcare provider computer 102 can further include a facsimile/printing device 180 operative to receive and print one or more adherence messages, as described herein. For example, as described further below, the service provider computer 104 may on occasion transmit a facsimile or other printing command to the healthcare provider computer 102 and/or the facsimile/printing device 180 containing one or more adherence messages indicating adherent or non-adherent behavior, along with information regarding any available or applied benefits. The transmission from the service provider computer 104 may be directed to the facsimile/printing device 180, such as may be accomplished via a network 110 (e.g., Internet, cellular network, wireless network, or any other similar network, etc.). In another embodiment, the transmission may be to the healthcare provider computer 102, which in turn communicates with and commands the facsimile/printing device 180 to provide the adherence message. Although the term facsimile/printing device is used throughout this description, it is appreciated that any other device operable to receive and print or generate a display of the adherence message may be included within the scope of a facsimile/printing device 180. Examples of other devices include, but are not limited to, a kiosk, a mobile device (e.g., cellular telephone, personal digital assistant, personal information device, etc.), a personal computer, a kiosk, or any other handheld or mobile devices.

The service provider computer 104 may be configured for receiving, processing, and fulfilling healthcare transaction requests from the healthcare provider, such as for claims adjudication processing, include pre- and/or post-adjudication editing, processing non-claim (e.g., 100% customer pay) payment transactions, and the like, as well as the additional monitoring, messaging, and benefits processing described herein. According to an example embodiment, the service provider computer 104 may comprise, but is not limited to, one or more “switches” or “switch providers” performing routing and processing of healthcare transactions between healthcare providers (e.g., pharmacies, prescribers, hospitals, etc.), payors/claims processors, third parties, and/or other service providers.

The service provider computer 104 and its associated DBMS 138 may be operable to access one or more databases, such as a data storage device 142, for storing and/or retrieving healthcare transaction information (e.g., healthcare transaction records and/or stored data regarding monitored patients/products, etc.), claim routing information, and claim adjustment criteria, for example. According to one embodiment, the data files 134 of the service provider computer 104 may also store routing tables for determining the subsequent transmission of a received claim or request. For example, these routing tables may determine that particular healthcare transactions are associated with certain payors (e.g., PBMs, insurance companies, etc.), and therefore specify a particular claims processor computer 108 where the healthcare transactions are routed. The host module 140 of the service provider computer 104 may initiate, receive, process, and respond to healthcare transactions from the respective client module 122 of healthcare provider computer 102, and may further initiate, receive, process, and respond to healthcare transaction adjudication replies from the host module 172 of the claims processor computer 108.

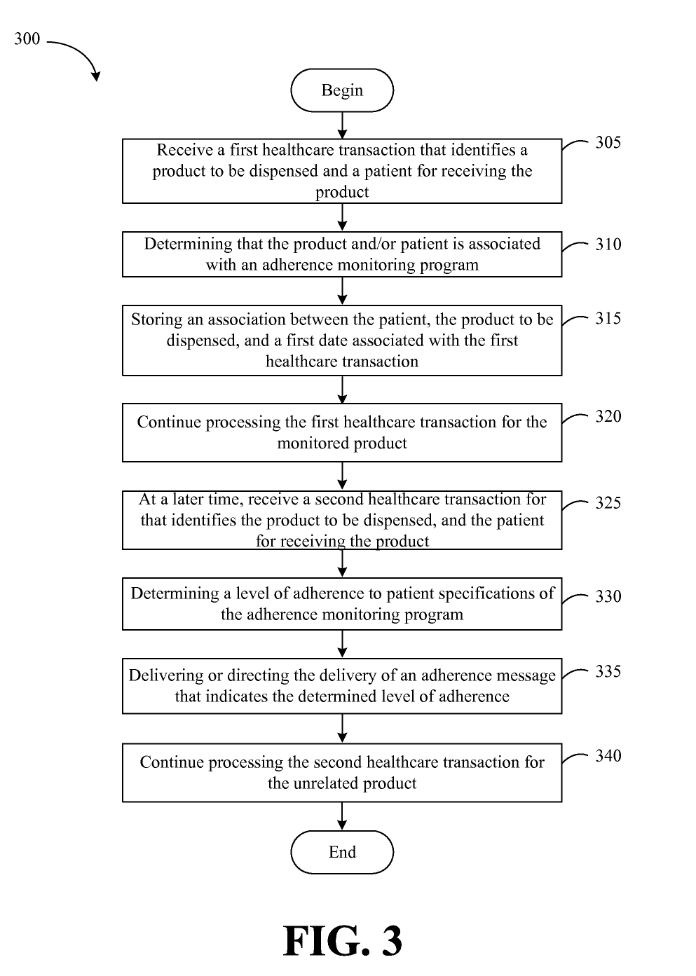

The service provider computer 104 may communicate with, or otherwise include, an adherence monitoring and benefits module 106, which may include computer-executable instructions operable to store, retrieve, and/or analyze healthcare transaction information associated with monitored patients/products, and to analyze subsequent healthcare transactions to determine adherence messages and benefits, such as is described in more detail with reference to FIGS. 3-5 herein. The adherence monitoring and benefits module 106 may access, or otherwise receive information from, the data storage device 142 and/or the data files 134 to examine stored data, processing logic, and/or prior historical claim transaction records, as described herein. The data storage device 142 and/or memory 128 may store, for example, but not limited to, records identifying patients enrolled in or associated with an adherence monitoring program, patient specifications for utilization of one or more products by patients, templates for adherence messages, patient history records (e.g., past healthcare transactions processed on behalf of a patient), product information, adherence message preferences, and the like, any of which may be accessed, updated, or otherwise used by the adherence monitoring and benefits module 106 when performing adherence-based monitoring, messaging, and benefits processing.

It is appreciated that in example embodiments, the adherence monitoring and benefits module 106 and/or the data storage device 142 may be provided in part or entirely within the service provider computer 104. In yet other embodiments, the adherence monitoring and benefits module 106 and/or the data storage device 142 may be part of a stand-alone processor-based computer or otherwise provided in part or entirely within one or more of the other entities' systems, such as at the healthcare provider computer 102 and/or at the claims processor computer 108. If the service provider computer 104 includes the adherence monitoring and benefits module 106 and/or the data storage device 142, then the data storage device 142 could also be part of the memory 128, and the adherence monitoring and benefits module 106 can be stored in the memory 128.

Although a single data storage device 142 is referred to herein for simplicity, it is appreciated that multiple physical and/or logical data storage devices or databases may be used to store the above mentioned data. For security and performance purposes, the service provider computer 104 may have a dedicated connection to the data storage device 142. However, the service provider computer 104 may also communicate with the data storage device 142 via the network 110 shown, or via another network. According to other embodiments, the service provider computer 104 may include the data storage device 142 locally. The service provider computer 104 may also otherwise be part of a distributed or redundant DBMS.

The claims processor computer 108 may be configured for receiving, processing, and fulfilling healthcare transaction requests from the healthcare provider computer 102 and/or the service provider computer 104 related to claims adjudication or other transaction processing. In some embodiments, the claims processor computer 108 may represent an insurance payor system or a government payor system.

The host module 172 of the claims processor computer 108 can be operable to receive, process, and respond to requests from the client module 122 of healthcare provider computer 102, and further to receive, process, and respond to requests from the host module 140 of the service provider computer 104. The claims processor computer 108 may include additional program modules for performing other pre-processing or post-processing methods performed by a claims processor.

Generally, the claims processor computer 108 may facilitate the determination of benefits, coverage, and/or extent of coverage for one or more healthcare transactions, such as prescription claim transactions. According to various embodiments, the claims processor computer 108 may be associated with a pharmaceutical benefits manager (“PBM”), an insurance company, or another third-party payor. According to another embodiment of the invention, the claims processor computer 108 may also be associated with providers of 100% copay plans such as discount programs. According to yet another embodiment, the claims processor computer 108 may be operated by, or otherwise included with, the service provider computer 104.

It is appreciated that each of the memories and data storage devices described herein for each of the healthcare provider computer 102, the service provider computer 104, and the claims processor computer 108 can store data and information for subsequent retrieval. The memories and data storage devices can be in communication with each other and/or other data storage devices, such as a centralized database, or other types of data storage devices. When needed, data or information stored in a memory or a data storage device may be transmitted to a centralized database capable of receiving data, information, or data records from more than one database or other data storage devices. In other embodiments, the data storage devices shown can be integrated or distributed into any number of databases or other data storage devices.

The network 110 may include any number of telecommunication and/or data networks, whether public, private, or a combination thereof, including a local area network, a wide area network, a publicly switched telephone network (“PSTN”), an intranet, the Internet, intermediate handheld data transfer devices, and/or any combination thereof and may be wired and/or wireless. The network 110 may also allow for real-time, off-line, and/or batch transactions to be transmitted between the healthcare provider computer 102, the service provider computer 104, and the claims processor computer 108. Due to network connectivity, various methodologies as described herein may be practiced in the context of distributed computing environments. Although the system 100 is shown for simplicity as including one intervening network 110, it is to be understood that any other network configuration is possible. For example, an intervening network 110 may include a plurality of networks, each with devices such as gateways and routers, for providing connectivity between or among networks 110. Instead of or in addition to a network 110, dedicated communication links may be used to connect the various devices in accordance with an example embodiment of the invention. For example, the service provider computer 104 may form the basis of the network 110 that interconnects the healthcare provider computer 102 and the claims processor computer 108.

The system 100 shown in and described with respect to FIG. 1 is provided by way of example only. Numerous other operating environments, system architectures, and device configurations are possible. Accordingly, embodiments of the invention should not be construed as being limited to any particular operating environment, system architecture, or device configuration.

Operational Overview

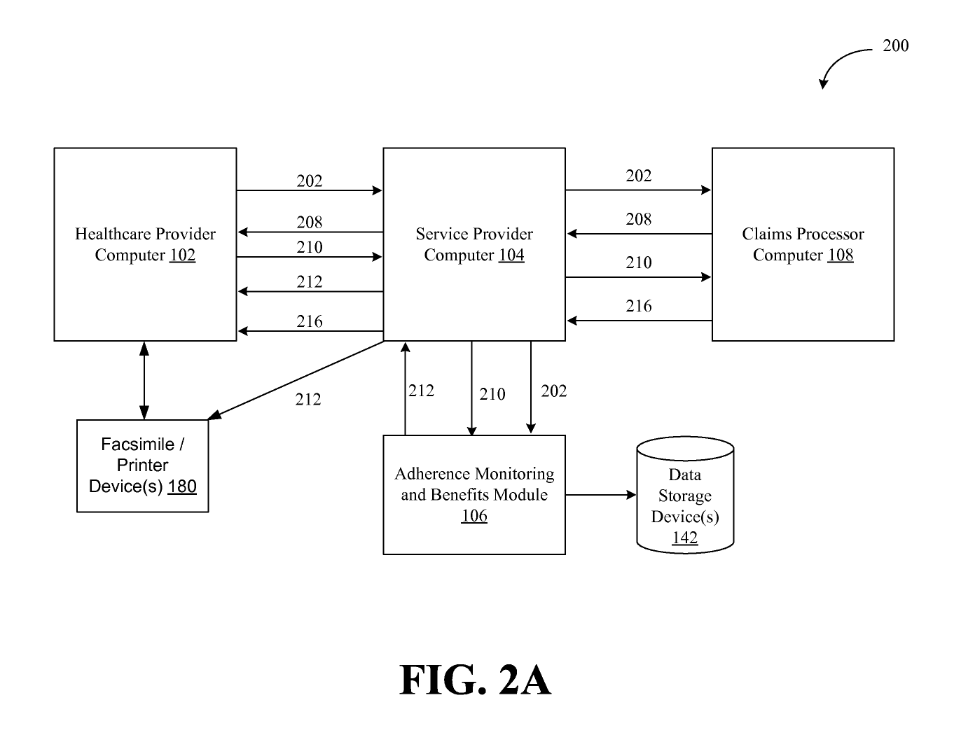

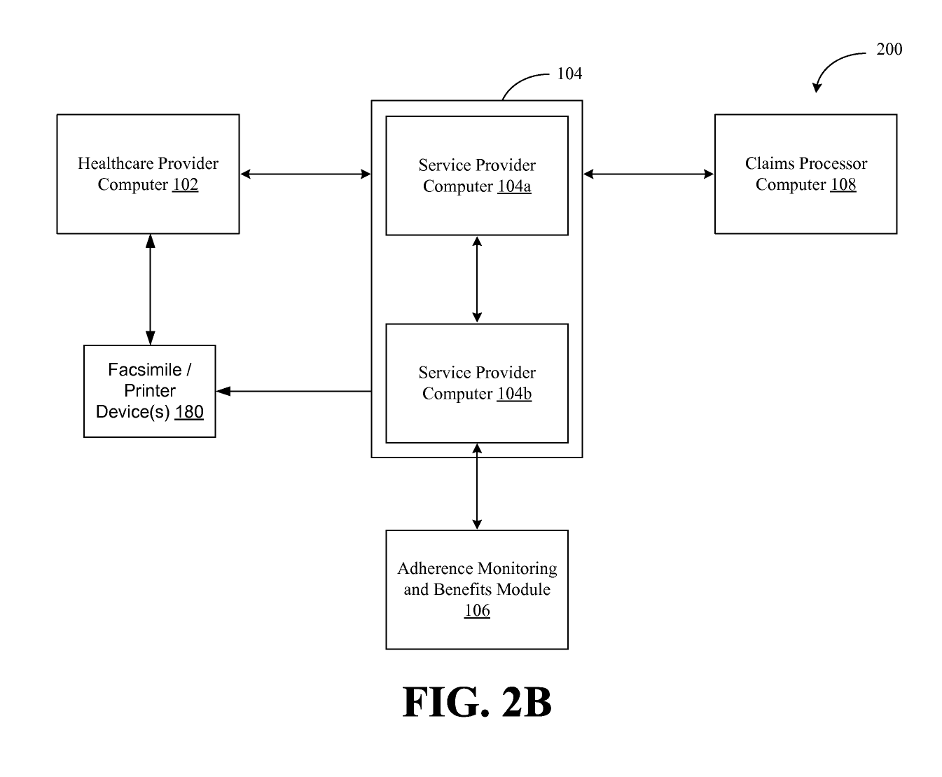

FIGS. 2A-2B are block diagrams representing example data flows of systems that may support adherence-based monitoring, messaging, and benefits processing, according to example embodiments of the invention. The data flows of and system relationships represented in the block diagrams of FIGS. 2A-2B will be discussed in conjunction with the flow diagrams of FIGS. 3-5.

FIG. 3 illustrates an overview of an example method 300 for performing adherence-based monitoring, messaging, and benefits processing, according to example embodiments of the invention. A request to fill a product for a patient (e.g., medication or other product or service) is received at a healthcare provider computer 102 (e.g., at a pharmacy computer system), upon which a first healthcare transaction 202 (also referred to interchangeably herein as a “healthcare request transaction,” “healthcare claim transaction,” or “claim transaction”) associated with the request is generated by the healthcare provider computer 102 and transmitted, or otherwise provided, to a service provider computer 104. For example, upon a patient seeking to fill a prescription for one or more drugs, medications, and/or other products at a pharmacy location or store, the pharmacy computer (i.e., the healthcare provider computer 102) can electronically transmit the healthcare transaction 202 over an electronic network, such as the network 110, to the service provider computer 104. In an alternative example embodiment, the healthcare provider or patient may communicate a healthcare transaction 202 via the Internet or over an interactive voice response unit (IVR) to the service provider.

Accordingly, at block 305, the service provider computer 104 may receive a first healthcare transaction 202 from the healthcare provider computer 102. To allow for adherence-based monitoring, messaging, and benefits processing, the healthcare transaction 202 includes at least an identity of the product to be dispensed (also interchangeably referred to herein as a “product identifier”) and an identity of the patient to whom the product is to be dispensed (also interchangeably referred to herein as a “patient identifier”). In some embodiments, the first healthcare transaction 202 may additionally include information indicating the days supply and dispense quantity for the product to be dispensed to the patient. According to an example embodiment of the invention, the healthcare transaction 202 may be provided in accordance with a version of a National Council for Prescription Drug Programs (NCPDP) Telecommunication Standard, although other standards may be utilized as well. As an example, a first healthcare transaction 202 received by the service provider computer 104 may include one or more of the following information:

Payor ID/Routing Information
BIN Number (i.e. Banking Identification Number), either alone or in combination with a Processor Control Number (PCN), that designates a destination of the healthcare transaction

Patient Information
Patient Last Name
Patient First Name
Date of Birth of Patient (e.g., to calculate the patient age, etc.)
Patient Gender Code
Patient Address (e.g., Street Address, Zip Code, etc.)
Patient Contact Information (e.g., Patient Telephone Number, email address, etc.)
Patient ID or other identifier

Insurance/Coverage Information
Cardholder Name (e.g., Cardholder First Name, Cardholder Last Name)
Cardholder ID and/or other identifier (e.g., person code)
Group ID and/or Group Information
Prescriber Information
Primary Care Provider ID or other identifier (e.g., NPI code)
Primary Care Provider Name (e.g., Last Name, First Name)
Prescriber ID or other identifier (e.g., NPI code, DEA number)
Prescriber Name (e.g., Last Name, First Name)
Prescriber Contact Information (e.g., Telephone Number)
Pharmacy or other Healthcare Provider Information (e.g., store name, chain identifier, etc.)
Pharmacy or other Healthcare Provider ID (e.g., National Provider Identifier (NPI) code)

Claim Information
Drug or product information (e.g., National Drug Code (NDC))
Prescription/Service Reference Number
Date Prescription Written
Quantity Dispensed
Days Supply (e.g., estimated number of days the prescription will last)
Fill Number (e.g., a Prescription Refill Identifier, etc.)
Number of Refills Authorized
Diagnosis Code (e.g., ICD9, ICD10, SNOMED, etc.)
Pricing information for the drug or product (e.g., network price, Usual & Customary Charge)
One or more NCPDP Message Fields

Date of Service.

It is appreciated that the aforementioned information is provided for illustrative purposes, and that any number of fields can be included in a first healthcare transaction 202 as is desired. Moreover, one or more of the aforementioned fields may be stored locally by the service provider computer 104, such as in a data storage device 142, and be retrieved based on one or more unique identifiers transmitted in the first healthcare transaction 202. In another example, some of the aforementioned fields indicating patient transaction history and/or other patient data may be stored locally and referenced by a patient identifier. In one example, a patient may optionally register with the service provider computer 104, and may then be assigned a patient identifier following successful registration. In other examples, payor data may be stored locally and referenced by a payor identifier, such as a BIN Number, PCN, or other payor identifier. Similarly, prescriber data and pharmacy data may also be stored locally and referenced by unique pharmacy identifiers and prescriber identifiers, respectively. This entity data may be collected directly from each entity (e.g., each payor, prescriber, and pharmacy), or it may be collected and stored in association with claim transactions processed for or on behalf of each entity.

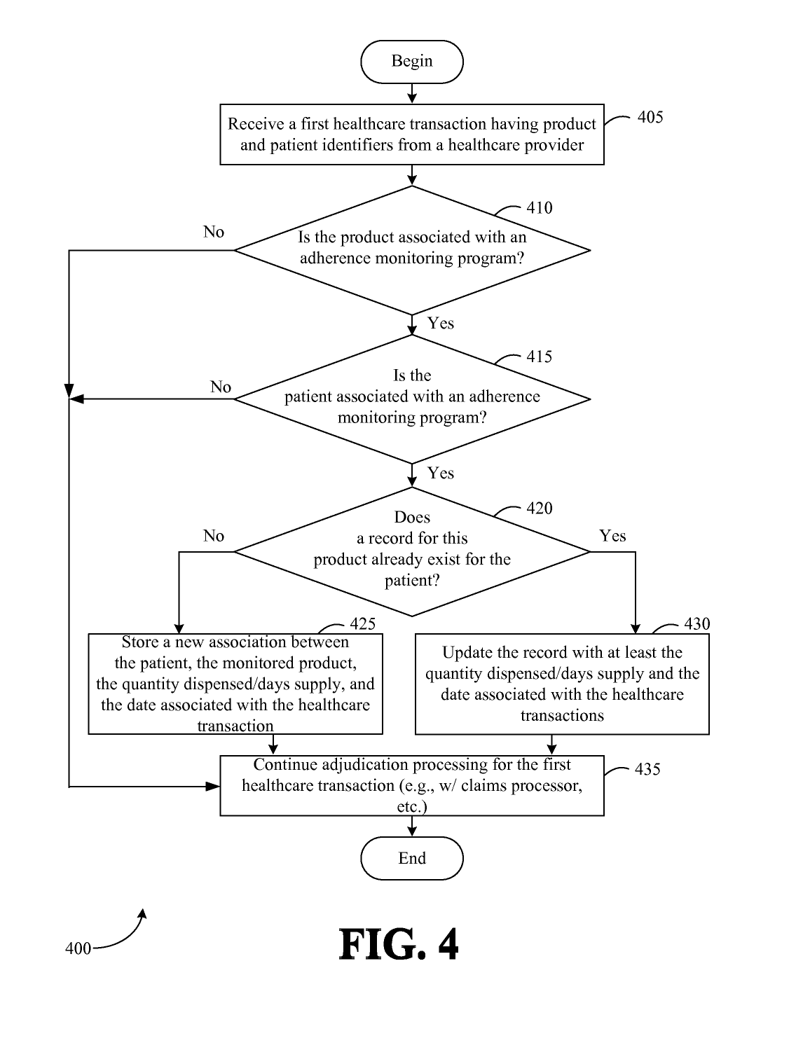

Following block 305 is block 310, in which the service provider computer 104 and/or adherence monitoring and benefits module 106 determines whether the product and/or patient identified by the first healthcare transaction 202 is associated with an adherence monitoring program. The adherence monitoring program may be associated with a Medication Therapy management program, or otherwise another monitoring program offered by a healthcare provider, a service provider, or another entity. Example processing for determining whether the product and/or patient is associated with an adherence monitoring program is described in more detail below with reference to FIG. 4. However, in general, an example determination includes identifying products that are being monitored by an adherence monitoring program. In addition or in the alternative, an example determination may also include determining whether the particular patient is enrolled in or otherwise associated with an adherence monitoring program, according to an example embodiment of the invention.

Following block 310 is block 315, in which the service provider computer 104 and/or the adherence monitoring and benefits module 106, stores in data storage device 142, a transaction record associated with the healthcare transaction 202. The information from the stored in the transaction record can depend on the type of adherence to be monitoring by the adherence monitored program. As an example, for refill-type adherence monitoring, the transaction record may store an association between the patient identified in the healthcare transaction 202, the product identified in the healthcare transaction 202, a date associated with the healthcare transaction 202, and a next refill date. The date associated with the healthcare transaction 202 may be a Date of Service specified by the healthcare transaction 202 or alternatively, a date of receipt of the healthcare transaction 202 by the service provider computer 104. The next refill date can be used to determine at least a first adherent time period in which a refill would be adherent or optimal, and a second non-adherent time period in which a refill would not be adherent or would be suboptimal. As an example, the first adherent time period may be prior to the next refill date while the second adherent time period. In an example embodiment of the invention, the next refill date can be determined from the days supply and/or quantity dispensed from the first healthcare transaction, as discussed in further detail with respect to FIG. 4. As an alternative to determining and storing the next refill date, the transaction record can alternatively or additionally store the days supply and/or dispense quantity indicated by the healthcare transaction 202. As another example, for concomitant-therapy type adherence monitoring, the transaction record may store similar information as for the refill-type adherence monitoring, but also include one or more product classification types that may be needed to subsequently determine whether the patient is utilizing two or more products or product types in accordance with the adherence monitoring program.

As part of the processing of block 315, service provider computer 104 and/or the adherence monitoring and benefits module 106, can further determine whether the product identified in the healthcare transaction 202 is the first time the product is being dispensed to a patient, or if it is for another fill or refill to replace a previously dispensed product. Accordingly, doing so permits the service provider computer 104 to track the most recently dispensed product, so as to avoid sending inaccurate adherence notifications for old products already replaced or refilled, or failing to provide benefits for otherwise adherent behavior. Moreover, in addition to receiving healthcare transactions 202 from a healthcare provider computer 102 for which the service provider typically conducts claim transaction processing, the service provider computer 102 may further receive transaction data, records, or other updates from a third-party (e.g., another competing service provider, a pharmacy not typically serviced by the service provider, a physician's office, the patient, etc.) indicating a refill or new fill of a product for a patient previously tracked by the service provider computer 104 in accordance with an adherence monitoring program.

After block 315 is block 320, in which the service provider computer 104 performs any additional processing associated with the healthcare transaction 202 received for the monitored product. For example, the service provider computer 104 may route, transmit, or otherwise deliver the healthcare transaction 202 to the claims processor computer 108 for processing and/or adjudication. In response, the claims processor computer 108 may receive and adjudicate the healthcare transaction 202. In particular, the claims processor computer 108 may determine benefits coverage for the drug or other product or service indicated by the healthcare transaction 202 according to a benefits determination process or other adjudication processing associated with determining eligibility, pricing, and/or utilization review. After performing its adjudication processing, the claims processor computer 108 may then transmit an adjudicated reply 208 that includes coverage information or a rejected status if not covered. As desired, upon receipt of the adjudicated reply 208, the service provider computer 104 may directly transmit the adjudicated reply 208 to the healthcare provider computer 102, or it may perform any number of post-adjudication edits on the adjudicated reply 208 prior to transmitting the adjudicated reply 208 to the healthcare provider computer 102.

It is appreciated that the steps of capturing and storing information from the first healthcare transaction 202 can occur after other processing of the healthcare transaction 202. For example, the operations of block 315 may be performed upon receiving the adjudicated reply 208 from the claims processor computer 108. Storing the information in the transaction record only upon receiving an adjudicated reply 208 for the corresponding healthcare transaction 202 may avoid any unnecessary storing and updating if, for example, the healthcare transaction 202 is rejected and the monitored product is not ultimately dispensed for the patient.

The operations illustrated in blocks 305, 310, 315, 320 can be performed by the service provider computer 104 and/or adherence monitoring and benefits module 106 for any number of patients at or near the time of dispensing products, permitting the service provider to generate an accumulation of transaction records for subsequent retrieval and analysis. Moreover, similar operations may be executed by the service provider computer 104 and/or adherence monitoring and benefits module 106 to update stored transaction records for a monitored patient upon fill or refill of a product to retain updated information.

It is further appreciated that the service provider computer 104 may receive healthcare transactions 202 from multiple different healthcare provider computers 102, and can thus generate a complete or near complete representation of a patient's history, irrespective of the pharmacy or other healthcare provider that fills or dispenses the product. For example, a patient can receive an initial fill for a monitored product at a first pharmacy, and then a refill at a different, unrelated pharmacy. During each of these fill and refill transactions, a healthcare transaction 202 is transmitted to the service provider computer 104 for tracking and updating transaction data irrespective of the pharmacy. Accordingly, a service provider that is advantageously positioned to process a large number of healthcare transactions with a large number of pharmacies or other healthcare providers is also advantageously positioned to generate and maintain transaction data that most accurately represents the patient's transaction history.

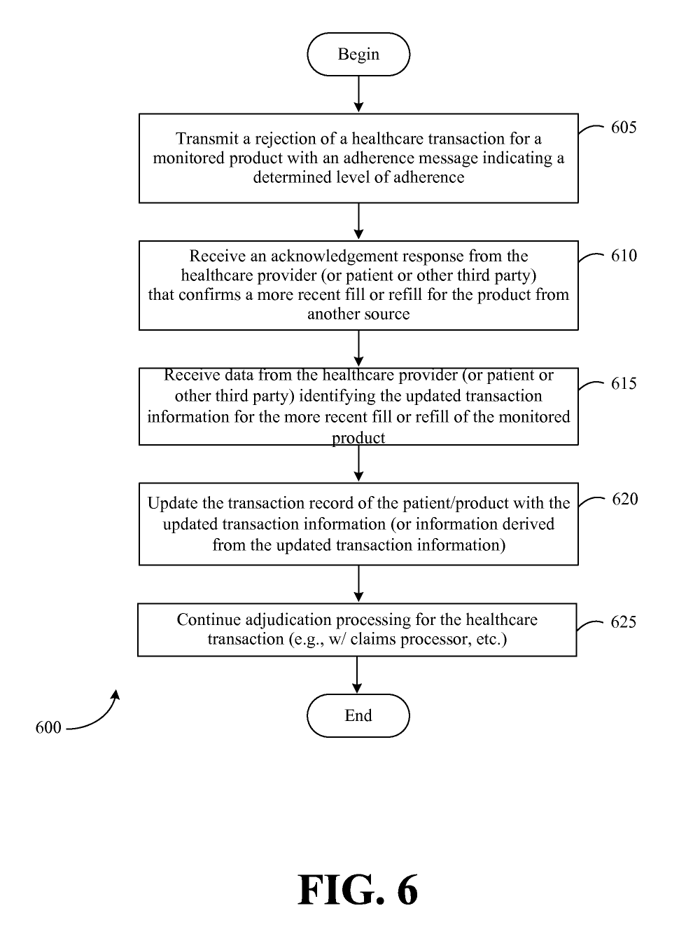

In situations in which a patient does fill or refill a monitored product with a healthcare provider that does not otherwise transact with the service provider computer 104 for other healthcare transaction processing, alternative processing can be provided for capturing the monitored product and refill data for storing an association therebetween, such as is described by example with reference to FIG. 6 below. For example, when a patient is visiting a healthcare provider and receives a negative adherence message that is inaccurate (e.g., “Improve Medication adherence”), for a product the patient already more recently filled or refilled, but which was not captured by the service provider computer 104, the patient can indicate as such. Receiving this indication could cause the healthcare provider to provide the fill or refill information to the service provider, or cause the service provider to initiate a request for updated information if not previously stored, such as from the healthcare provider, the patient, or a third-party entity. Many other processes can occur to generate a record for the patient, such as but not limited to, healthcare provider and/or patient access through a web portal accessible over the Internet or other network; healthcare provider and/or patient access via an interactive voice response unit; integration or other communication with a different service provider; and the like.

Following block 320 is block 325, in which the service provider computer 104 receives a second healthcare transaction 210 from a healthcare provider computer 102 for processing on behalf of the same patient. This second healthcare transaction 210 is received at some later time than the first healthcare transaction 202 and for the same product as the one of the first healthcare transaction 202. Like the first healthcare transaction 202, the second healthcare transaction 210 includes at least an identity of the product and the identity of the patient, as well as any other number of data elements, such as are described above with reference to block 305. For example, at a later time when the patient visits a pharmacy for a fill or refill of a product, the service provider computer 104 can perform adherence-based monitoring, messaging, and benefits processing for monitored products that have previously been dispensed to the patient (from the same or a different healthcare provider). Again, because the service provider is advantageously positioned to receive and process a substantial number of healthcare transactions, the service provider is well-positioned to leverage its potential multiple points of interaction with the patient and/or healthcare providers on behalf of the patient to perform these additional monitoring, messaging, and other value-add (e.g., adherence-based benefits) processing on behalf of the patient.

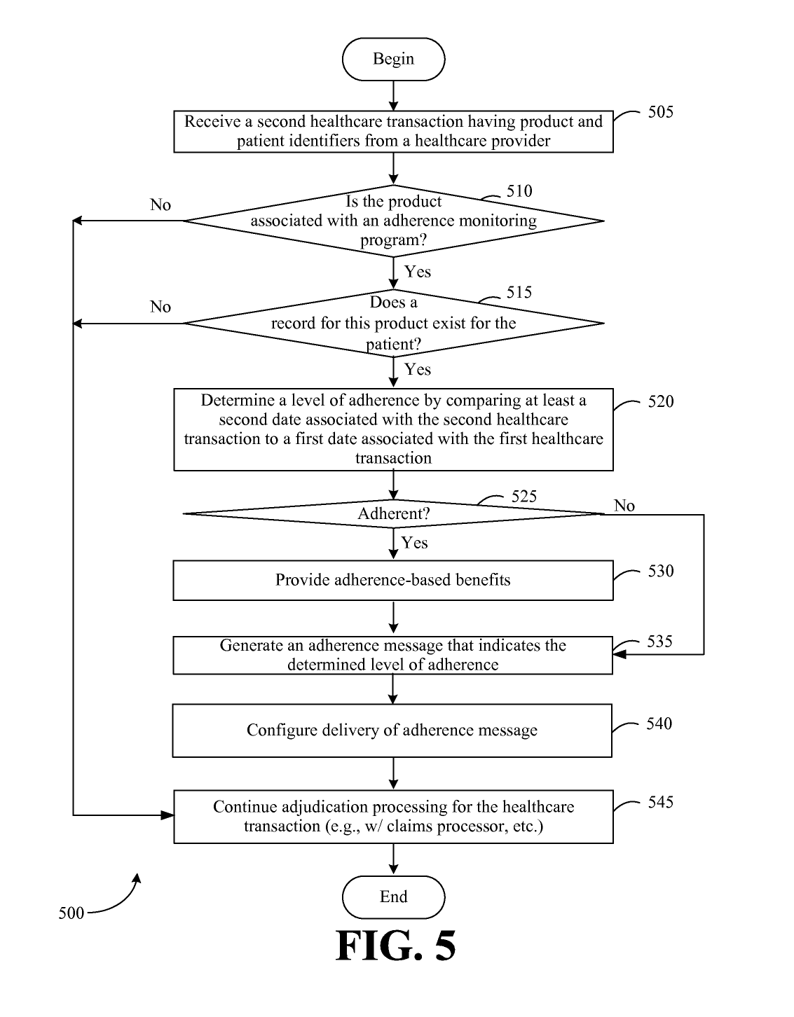

Accordingly, upon receipt of the second healthcare transaction 210 at block 330, the service provider computer 104 and/or the adherence monitoring and benefits module 106, can perform adherence-based monitoring processing to determine whether the patient has previously been dispensed the monitored product for determination of a level of adherence to an adherence monitoring program, which is described in further detail with reference to FIG. 5 below.

Indeed, the previously stored data stored at block 315—for example, the associations between patients, products, transaction dates, and next refill dates—can be analyzed in conjunction with the healthcare transaction 210 to determine the level of adherence. According to an example embodiment, at block 330, the service provider computer 104 and/or the adherence monitoring and benefits module 106 can compare information from the second healthcare transaction 210 to the stored transaction record associated with the first healthcare transaction 202 to determine a level of adherence to the adherence monitoring program. As an example, for refill-type adherence monitoring, stored transaction record may indicate a next refill date for the product, or alternatively the days supply/dispense quantity for determining the next refill date. If the transaction date of the second healthcare transaction 210 is on or prior to the next refill date, then the fill or refill associated with the second healthcare transaction 210 may be determined to be adherent. However, if the second healthcare transaction is after the next refill date, then the second healthcare transaction 210 may be determined to non-adherent, which will also described in more detail with reference to FIG. 5 below.

At block 330, the determination of the level of adherence to the adherence monitoring program may determine the type of adherence message that will be generated at block 335 below. Likewise, the determination of the level of adherence to the adherence monitoring program may whether or the extent to which financial benefits may be provided to the patient. As an example, financial benefits may be provided to the patient in order to encourage, maintain, or improve adherent behavior. These financial benefits may be in the form of vouchers or payments that may reduce a patient responsibility amount that may remain following adjudication of the healthcare transaction 210. However, it is appreciated that the financial benefits may take other forms as well, including for example, the accumulation of rewards points by the patient and which can be redeemed for one or more products, services, or rebates.

At block 335, the service provider computer 104 and/or the adherence monitoring and benefits module 106 can generate and deliver an adherence message 212 to the healthcare provider computer 102, or alternatively, directly to the patient (e.g., via email or Internet message, text message to cellular phone, fax, etc.). The adherence message 212 may indicate an adherent or non-adherent behavior, and likewise any benefits (e.g., financial benefits) that are available or other provided to the patient. As described herein, the adherence message 212 may be provided as part of a healthcare transaction, perhaps as part of a reject message or appended to an adjudicated response, according to an example embodiment of the invention. In addition or in the alternative, another adherence message 212 could also be delivered to a facsimile/printer device 180 associated with the healthcare provider. For example, the service provider computer 104 can cause the adherence message 212 to be delivered via a printing or facsimile command to a facsimile/printer device 180 operative with the healthcare provider computer 102 or otherwise associated with the healthcare provider. The adherence message 212 delivered to the facsimile/printer device 180 could include the same information as that provided as part of a healthcare transaction, but could also include a more detailed explanation regarding any applied benefits or one or more reasons for the determined adherent or non-adherent behavior.

Following block 335 is block 340, in which the service provider computer 104 continues to perform the primary processing associated with the second healthcare transaction 210, such as claim adjudication with a claims processor computer 108. For example, the second healthcare transaction 210, or information pertaining thereto, can then be transmitted to the claims processor computer 108, and a second adjudicated reply 216 be received in response thereto.

It is appreciated that the operations of generating and transmitting an adherence message 212 can occur after other processing of the second healthcare transaction 210. For example, the operations in block 325-335 may be performed upon receiving a second adjudicated reply 216 from the claims processor computer 108 for the second healthcare transaction 210. In addition, the adherence message 212 may comprise a part of the a second adjudicated reply 216, perhaps in a message field of the second adjudicated reply 216, according to an example embodiment of the invention.

The method 300 may end after block 340. Example processing associated with adherence-based monitoring, messaging, and benefits processing is now described in additional detail with reference to FIGS. 4-6 below.

FIG. 4 illustrates an example method 400 for capturing transaction information for patient in accordance with an adherence monitoring program when a relevant product is dispensed to a patient, such as is initially described with reference to blocks 305, 310, 315 of FIG. 3 above. Some or all of the below operations of the method 400 described with reference to FIG. 4 are performed by any suitable service provider computer and processing logic, such as the service provider computer 104 executing and the adherence monitoring and benefits module 106 described with reference to FIG. 1.

The method 400 begins at block 405, in which a first healthcare transaction 202 is received from a healthcare provider computer 102 which includes a product identifier and a patient identifier, as well as any other information related to the healthcare transaction, including the days supply and/or dispense quantity, such as is described with reference to block 305 of FIG. 3 above. For example, the healthcare transaction 202 is transmitted to the service provider computer 104 for typical processing, such as claims adjudication processing, pre- and/or post-adjudication editing, and the like.

At decision block 410, upon receipt of the first healthcare transaction 202, the service provider computer 104 analyzes the first healthcare transaction 202, namely the product identifier (e.g., NDC), to determine whether the adherence program is configured to monitor the product identified in the healthcare transaction 202. Any number of techniques may be used to determine whether the adherence monitoring program is configured to monitor the product identified in the healthcare transaction 202. For example, the service provider computer 104 may compare the product identifier (e.g., NDC) in the healthcare transaction 210 to a list of identifiers for products being monitored under the adherence monitoring program.

If it is determined at decision block 410 that the product is not being monitored by an adherence monitoring program, then processing continues to block 435 in which conventional processing of the healthcare transaction 202 continues (e.g., adjudication processing with a claims processor, pre- and/or post-editing processing, etc.). However, if it is determined at block 410 that the product is being monitored by an adherence monitoring program, then processing proceeds to decision block 415.

At block 415, the service provider computer 104 may determine whether the patient is enrolled in or otherwise associated with the adherence monitoring program. Any number of techniques may be used to determine whether the patient is enrolled in or otherwise associated with an adherence monitoring program, including but not limited to, comparing a patient identifier (e.g., Cardholder ID/person Code, patient first/last name & DOB, etc.) to a list or other stored data (e.g., the data storage device 142, etc.) containing identifiers for patients that are enrolled or associated with an adherence monitoring program. According to an example embodiment of the invention, this list or other stored data may have been received based upon a patient enrolling in the adherence monitoring program by a variety of electronic or non-electronic communication means, which may include registrations at a pharmacy or physician location, via a webpage or Internet portal, an interactive voice response (IVR) system or call center, email or Internet message, facsimile, a paper registration, etc.

If it is determined at decision block 415 that the patient is not enrolled in or otherwise associated with the adherence monitoring program, then processing continues to block 435 in which conventional processing of the healthcare transaction 202 continues (e.g., adjudication processing with a claims processor, pre- and/or post-editing processing, etc.). However, if it is determined at block 415 that the patient is enrolled in or otherwise associated with the adherence monitoring program, then processing proceeds to decision block 420.

At block 420, the service provider computer 104 determines whether any transaction record of the patient exists that is associated with the product of the healthcare transaction 202. For example, the service provider computer 104 can analyze the transaction records having stored associations between patients and products to determine whether an association between the patient and the product indicated in the healthcare transaction 202 already exists (or within a particular time frame). In another example, other transaction history information pertaining to the patient's past transactions can be analyzed to determined whether the patient has previously been dispensed the product. The existence of an association (or any other indication that the patient has previously been dispensed the product) can be used to trigger the service provider computer 104 to process the current healthcare transaction 202 as an update transaction, instead of a new product transaction.

If it is determined at decision block 425 that no transaction record of the patient exists that is associated with the product of the healthcare transaction 202, then block 430 follows. In block 430, a new transaction record may be generated based upon information associated with the healthcare transaction 202. The transaction record may include at least the patient identified by the healthcare transaction 202, the product identified by the healthcare transaction 202, a date associated with the healthcare transaction. The transaction record can also include the days supply and/or quantity dispensed. Alternatively or additionally, the transaction record can also store a next refill date.

In an example embodiment of the invention, the next refill date that is stored in the transaction record can be determined from the days supply and/or quantity dispensed from the healthcare transaction 202. For instance, a days supply for the product may indicate a supply of X days, which may be 30 days (or 1 month), 60 days (or 2 months), 90 days (or 3 months), or another time period. The days supply may define how long a current supply of the product should last. As an example, if a patient receives X days supply of the product on a current date, then the patient may be expected to need a refill approximately X days from the date that the product was filled. As such, if the days supply is X days, then a next refill date may be calculated as X days from a current date associated with the healthcare transaction 202. However, the next refill date can also be slightly adjusted by a predetermined time period (e.g., a predetermined number of days later) since most patients may refill a product prior to being completing out of an existing supply of a product. The next refill date can be used to determine at least a first adherent time period in which a refill would be adherent or optimal, and a second non-adherent time period in which a refill would not be adherent or would be suboptimal. As an example, the first adherent time period may be prior to the next refill date while the second adherent time period.

While the next refill date described above is determined based upon the days supply, the quantity dispensed may likewise be utilized to determine the next refill period. The adherence monitoring program may provide patient specifications for utilization of the product. The patient specifications may be based upon prescriber instructions, pharmaceutical manufacturer guidelines, medication guides, or otherwise specified for the patient in accordance with a mediation therapy management program or adherence program provided by or supported by one or more healthcare providers (e.g., pharmacist, physician, etc.). These respective patient specifications may be provided in the stored data (e.g., the data storage device 142, etc.) in conjunction with respective patients that are enrolled or associated with an adherence monitoring program, according to an example embodiment of the invention.

By way of example, if the patient specifications indicate that the product is to be utilized at one unit per day, then a dispense quantity of 90 units may reflect a 90 day supply. As another example, if the patient specifications indicate that the product is to be utilized at three units per day, then a dispense quantity of 90 units may reflect a 30 day supply. Once the days supply is calculated, the next refill date can be determined as similarly discussed above.

Thus, the next refill date and other information described herein may be stored in a transaction record at block 425 for subsequent retrieval and analysis when performing adherence-based monitoring, messaging, and benefits processing, such as is described in more detail with reference to FIG. 5. According to one embodiment, as part of the transaction record, adherence messaging preferences can be stored, such as patient preferences, healthcare provider preferences, manufacturer preferences, and the like.

If, however, it is determined at decision block 420 that no transaction record of the patient exists that is associated with the product of the healthcare transaction 202, then block 430 follows. At block 430, the service provider computer 104 performs update processing on the previously stored transaction record. In particular, the transaction record may be updated to further specify for a particular product for a patient, a date associated with the healthcare transaction 202, along with other information similarly described with respect to block 425 such as the days supply/quantity dispensed and/or the next refill date.

Accordingly, by updating any previously stored associations, whether by overwriting or by creating a new record, the service provider computer 104 can more intelligently monitor based on the most-recently dispensed version of the product, and inadvertently avoid delivering inaccurate adherence messages or failing to provide adherence-based benefits.

It is further appreciated that, according to some embodiments, the service provider computer 104 may also receive information for a patient from a third party (such as a non-participating healthcare provider, etc.) with new or updated fill or refill information for a previously dispensed product. This information can be provided according to any number of means, as further described with reference to FIG. 6 below. By gathering information from other third parties, the service provider can store a more complete patient transaction history and perform up-to-date adherence-based monitoring, messaging, and benefits processing.

Following block 425 or 430 is block 435, in which the service provider computer 104 continues any other processing of the healthcare transaction 202. For example, the service provider computer 104 may route, transmit, or otherwise deliver the healthcare transaction 202 to the claims processor computer 108 for processing and/or adjudication. The service provider computer 104 may optionally perform pre-adjudication editing on the healthcare transaction 202 prior to transmission to the claims processor computer 108 for adjudication. In response, the claims processor computer 108 may receive and adjudicate the healthcare transaction 202. After performing its adjudication processing, the claims processor computer 108 may then transmit an adjudicated reply 208 that includes coverage information or a rejected status if not covered. As desired, upon receipt of the adjudicated reply 208, the service provider computer 104 may directly transmit the adjudicated reply 208 to the healthcare provider computer 102, or it may perform any number of post-adjudication edits on the adjudicated reply 208 prior to transmitting the adjudicated reply 208 to the healthcare provider computer 102.

As described above with reference to FIG. 3, in other embodiments, the operations of capturing and storing transaction data, such as in blocks 410-430, can occur after other processing of the healthcare transaction 202 at block 435.

In addition, in accordance with one example embodiment, a reversal of the original healthcare transaction 202 may occur after processing is completed at block 435. For example, a healthcare transaction reversal may be performed when a healthcare provider determines that the prescription information was in error, and has not corrected the prescription information. In response to such healthcare transaction reversals, the service provider computer 104 may process a reversal request to remove or otherwise indicate that the previously received healthcare transaction request was cancelled, that the healthcare transaction should not be adjudicated with a claims processor or that the prescription request should not be subsequently transmitted to a pharmacy for filling, and that the monitored product information should no longer be considered as part of the patient's history. Accordingly, the service provider computer 104 may include additional processing logic to update the transaction record, which may include stored associations between the patient, the product, the transaction date, and/or the days supply/dispense quantity or next refill date. The service provider computer 104 may delete the association, or otherwise indicate that the captured transaction data is not valid due to the healthcare transaction reversal. By updating the stored associations, the service provider computer 104 is able to enable more accurate, complete, up-to-date adherence-based monitoring, messaging, and benefits processing.

It will be appreciated that many variations of FIG. 4 are available without departing from example embodiments of the invention. For example, the patient checking for an association or enrollment in an adherence monitoring program in block 415 may be optionally eliminated such that block 410 may flow directly into block 420.

FIG. 5 illustrates an example method 500 for adherence-based monitoring, messaging, and benefits processing in response to another healthcare transaction, such as is initially described with reference to blocks 325-340 of FIG. 3 above. The adherence-based monitoring, messaging, and benefits processing of this example method 500 can be performed at some later time after the receipt of the first healthcare transaction 202 for the monitored product. For example, at a later time when the patient visits a pharmacy for a fill or refill of a product, the service provider computer 104 can perform the adherence-based monitoring, messaging, and benefits processing. Some or all of the below operations of the method 500 described with reference to FIG. 5 are performed by any suitable service provider computer and processing logic, such as the service provider computer 104 executing the adherence monitoring and benefits module 106 described with reference to FIG. 1.

The method 500 begins at block 505, in which a second healthcare transaction 210 (interchangeably referred to herein as “second healthcare transaction,” “subsequent healthcare transaction,” and/or any variants or equivalents thereof) is received from a healthcare provider computer 102 which includes a product identifier and a patient identifier, as well as any other information related to the healthcare transaction, including the days supply and/or quantity dispensed, such as is initially described with reference to block 320 of FIG. 3 above. The healthcare provider computer 102 can be associated with the same healthcare provider that transmitted the healthcare transaction 202 for the monitored product, as described above with reference to FIG. 4, or associated with another related or unrelated healthcare provider.

Upon receiving the second healthcare transaction 210, at decision block 510, the service provider computer 104 analyzes the first healthcare transaction 202, namely the product identifier (e.g., NDC), to determine whether the adherence program is configured to monitor the product identified in the healthcare transaction 202. Any number of techniques may be used to determine whether the adherence monitoring program is configured to monitor the product identified in the healthcare transaction 202. For example, the service provider computer 104 may compare the product identifier (e.g., NDC) in the healthcare transaction 210 to a list of identifiers for products being monitored under the adherence monitoring program.

If it is determined at decision block 510 that the product is not being monitored by the adherence monitoring program, then processing continues to block 545 in which conventional processing of the healthcare transaction 210 continues (e.g., adjudication processing with a claims processor, pre- and/or post-editing processing, etc.). However, if it is determined at block 510 that the healthcare transaction 202 is associated with an adherence monitoring program, then processing proceeds to decision block 515. At block 515, the service provider computer 104 determines whether a previously stored transaction record exists for the patient (or exists within a time frame), where the transaction record is associated with the product identified by the healthcare transaction 210. The existence of the prior transaction record may be needed for use in adherence-based monitoring to determine whether the patient behavior associated with the healthcare transaction 210 is adherent in accordance with the adherence monitoring program.

If it is determined in block 515 that no previously stored transaction record exists for the patient/product, then processing continues to block 545 in which conventional processing of the healthcare transaction 210 continues (e.g., adjudication processing with a claims processor, pre- and/or post-editing processing, etc.). However, if it is determined in block 515 that a previously stored transaction record exists for the patient/product, then processing may proceed to block 520.

At block 520, the service provider computer 104 may obtain information from the previously stored transaction record, which may include a date associated with the prior healthcare transaction 202 and the next refill date (or alternatively days supply/quantity dispensed). For a refill-based adherence determination, the service provider computer 104 may compare a current transaction date associated with the second healthcare transaction 210 to a next refill date from the stored transaction record. If the current transaction date is less than or equal to the next refill date, then the fill or refill associated with the second healthcare transaction 210 may determined to be “adherent”. On the other hand, if the current transaction date is greater than the next refill date, then the fill or refill associated with the second healthcare transaction 210 may determined to be “not adherent”. However, it will be appreciated that the level of adherence may include other gradations than simply adherent or not adherent. For example, a fill or refill may be “almost adherent” if it occurs only a predetermined amount of time (e.g., 5 to 7 days) after the next refill date. Likewise, the manner of determining adherent or non-adherent time periods in relation to the next refill date may be varied without departing from example embodiments of the invention. For example, there may be a short time period after the next refill date in which the fill or refill may still be determined to be “adherent”. As described above, in other embodiments, the days supply and/or dispense quantity may be utilized to effectively calculate the next refill date where the next refill date was not previously stored. Likewise, in another example, patient history, instead of a stored association, can be analyzed for the patient to determine the length of time between refills, which is used to determine a level of adherence for the patent refilling a product.

Following block 520 is block 525. Block 525 may include determining whether an acceptable level of adherence was determined at block 520 such that one or more benefits can be provided for the patient. If block 525 does not determine an acceptable level of adherence, then processing proceeds to block 535 for the generation on the adherence message that indicates the determined level of adherence. On the other hand, if block 525 determines an acceptable level of adherence, then processing may proceed to block 530.

At block 530, the service provider computer 530 may provide one or more benefits, including financial benefits, to the patient based upon the acceptable level of adherence. In one example embodiment of the invention, the financial benefit may be an electronic voucher, coupon, or discount that may be available to reduce a patient responsibility amount for a current or future fill or refill of the product for the patient. As an example, the voucher, coupon, or discount may be used to immediately reduce, by a predetermined amount, the patient responsibility amount determined specified by a response 216 from the claims processor computer 108. Alternatively, the voucher, coupon, or discount may be made available to the patient on a future fill or refill of the product. Likewise, the voucher, coupon, or discount may be automatically made available, for the current healthcare transaction 210 or for a future healthcare transaction, without requiring the patient request application of the voucher, coupon, or discount. It is appreciated that the voucher, coupon, or discount could also be made available for other product(s) different than the one for the second healthcare transaction 210. The vouchers, coupons, or discounts may be funded by a healthcare provider (e.g., a pharmacy), a service provider, a pharmaceutical manufacturer, or another entity or organization.

In another example embodiment, the financial benefit may instead be in the form of rewards points, which may be redeemed for products, services, or rebates. The patient may be able to view or redeem the rewards points via an Internet portal, call center, or interactive voice response (IVR) system. However, in another example embodiment, the rewards points may be automatically redeemed once certain thresholds or other requirements are met. For example, the patient may accumulate rewards points on each adherent fill or refill of a product such that once a threshold amount of rewards points is accumulated, the rewards points may be automatically redeemed for a financial benefit, perhaps to reduce the patient-responsibility amount for a current healthcare transaction.

Following block 530 is block 535, where the service provider computer 104 generates an adherence message 212 to notify the patient of the determined level of adherence to the adherence monitoring program. The adherence message 212 may include any amount of information, including, but not limited to, product identifier, patient identifier, a last refill date (of first transaction 202) prior to the current refill date (of second transaction 210), and the like. The adherence message 212 may vary depending on the determined level of adherence at block 520, and whether any benefits were provided in . Example adherence messages 212 may include:
“Medication Adherence for [Product Name] is Excellent! Continue this good behavior”
“Medication Adherence for [Product Name] is Excellent! An electronic voucher of [discount amount] has been applied to this transaction. Continue this good behavior”
“Improve Medication Adherence for [Product Name]—Take as prescribed.
“Improve Medication Adherence for [Product Name]—Take as prescribed. You can qualify for an electronic voucher of [discount amount] if your next refill of [Product Name] occurs by [next refill date].

It is further appreciated that additional information may be provided in the adherence message 212, such as, but not limited to, possible negative consequences, other risks, cross-sell messages, up-sell messages, and the like. The adherence message 212 may vary, depending upon the situation for which it is being generated (e.g., vary by product, by healthcare provider, by patient, by level of adherence, etc.). Any of the information to be included in the adherence message 212 can be retrieved from stored data, such as from the data storage device 142. It is appreciated that the information included with the adherence message 212 may be based upon how the adherence message 212 is to be delivered, whether as part response to the healthcare transaction 210 or via email or Internet message, SMS text message, facsimile, voicemail, etc.

Following block 535 is block 540. At block 540, the adherence message 212 may be configured for delivery to the patient or healthcare provider. For delivery to the patient, the adherence message 212 may be configured for delivery by electronic, voice, and/or written communication (e.g., via email or Internet message, SMS text message, facsimile, voicemail, etc.). In another example, the adherence message 212 may be transmitted to another healthcare provider, such as to the patient's prescribing physician, or to a claims processor, such as to a third-party payor, which may be useful to provide updates as to the patient adherence levels. As an example, an adherence message 212 may be transmitted to the patient's prescribing physician, perhaps via facsimile, printer, or email or Internet message, according to an example embodiment of the invention.

According to an example embodiment, for delivery to a healthcare provider, the adherence message 212 may delivered to the facsimile/printer device 180, either directly or indirectly via the healthcare provider computer 102. Alternatively, the adherence message 212 may be appended to message field in a response 216 from the claims processor computer 108, and the updated response 216 can be delivered to the healthcare provider computer 102. As another alternative, the adherence message 212 may be generated as a reject message with a unique reject or status code, notifying the healthcare provider computer 102 the purpose of the rejection. A reject message may be helpful to obtain the attention of the healthcare provider operating the healthcare provider computer 102 to indicate an out-of-the-ordinary processing. If transmitted as a reject message, the adherence message 212 may optionally include an override code that the operator at the healthcare provider can input as a response to the reject message, instructing the service provider computer 104 to continue processing the healthcare claim transaction 210. One or more override codes (or other responses) may indicate a status, such as the action taken by the healthcare provider or the patient.

At block 540, the service provider computer 104 optionally receives a response 214 to the adherence message 212. For example, if the adherence message 212 is transmitted as a reject message to a healthcare provider 102 (e.g., a pharmacy, etc.), a response 214 is transmitted from the healthcare provider computer 102 with an override or any other status indicator to permit the service provider computer 104 to continue processing the healthcare transaction 210 accordingly (e.g., adjudication or other processing). In one embodiment, the response 214 may indicate that the patient has refilled a product earlier than that which that the service provider was aware of. Receiving such a response 214 may cause the service provider to initiate processing to receive updated transaction information (e.g., refill information), such as is described in more detail with reference to FIG. 6. In another embodiment, however, a response 214 is not required, such as if the adherence message 212 is not transmitted as a reject message or if transmitted directly to a patient, for example.

Following block 540 is block 545, in which the service provider computer 104 continues any other processing of the second healthcare transaction 210. For example, the service provider computer 104 may route, transmit, or otherwise deliver the second healthcare transaction 210 to the claims processor computer 108 for processing and/or adjudication. The service provider computer 104 may optionally perform pre-adjudication editing on the second healthcare transaction 210 prior to transmission to the claims processor computer 108 for adjudication. In response, after performing its adjudication processing on the second healthcare transaction 210, the claims processor computer 108 may then transmit an adjudicated reply 216 that includes coverage information or a rejected status if not covered. As desired, upon receipt of the adjudicated reply 216, the service provider computer 104 may directly transmit the adjudicated reply 216 to the healthcare provider computer 102, or it may perform any number of post-adjudication edits on the adjudicated reply 216 prior to transmitting the adjudicated reply 216 to the healthcare provider computer 102. An example of a post-adjudication edit is the reduction of the patient responsibility (e.g., co-pay amount) by any voucher, coupon, or discount amount determined by block 530, according to an example embodiment of the invention.

It will be appreciated that many variations of FIG. 5 are available without departing from example embodiments of the invention. According to an example alternative embodiment, there may optionally be an additional block prior to block 520 for determining whether the patient is enrolled in or otherwise associated with the adherence monitoring program. For example, the patient identifier (e.g., Cardholder ID/person Code, patient first/last name & DOB, etc.) of the healthcare transaction 210 may be used to determine whether the identified patient is enrolled in or otherwise associated with an adherence monitoring program. Any number of techniques may be used to determine whether the patient is associated with an adherence monitoring program, including but not limited to, comparing a patient identifier to a list or other stored data (e.g., the data storage device 142, etc.) containing identifiers for patients that are enrolled or associated with an adherence monitoring program.

Likewise, in another alternative embodiment, the service provider computer 104 may additionally review preferences to determine whether the patient and/or the healthcare provider is to be included or excluded from adherence-based monitoring, messaging, and benefits processing. For example, in one embodiment, a patient may be given the opportunity to opt out of receiving adherence messages or benefits (e.g., via a response provided to the pharmacy, over the Internet, over the telephone, etc.). In another example, a pharmacy or other healthcare provider may indicate a preference not to receive adherence messages. Preferences may be stored and updated by the service provider computer 104, such as in the data storage device 142, and accessed while performing adherence-based monitoring, messaging, and benefits processing.

As described above with reference to FIG. 3, in other embodiments, the operations of analyzing stored associations for monitored products and generating and transmitting notification messages, such as in blocks 510-540, can occur after other processing of the second healthcare transaction 210 at block 545. For example, the adherence message 212 may be an appended message of the adjudicated reply 216 that is delivered to the healthcare provider computer 102, according to an example embodiment of the invention.

It will also be appreciated that the information associated with second healthcare transaction 210 can similarly be stored or updated in a transaction record, as similarly described with respect to the first healthcare transaction 202 in FIG. 4. In this way, the service provider computer 104 can maintain up-to-date transaction information for adherence-based monitoring, messaging, and benefits processing when a subsequent healthcare transaction is received.

FIG. 6 illustrates an example method 600 for receiving updated prior transaction information from a healthcare provider (or a patient or other third party), such as is initially described with reference to FIG. 3. In one example, the third party may be another healthcare provider that does not typically perform transaction processing with the service provider computer 104, or the third party can be the patient providing updated transaction information directly to the service provider computer 104. According to yet another embodiment, a claims processor, such as a third party payor, can act as the third party entity in this embodiment, in which the claims processor transmits updated transaction information to the service provider computer 104 for claims it adjudicated on behalf of the patient but not submitted via the service provider computer 104.

Accordingly, capturing updated transaction information regarding a fill or refill of a product for a patient that was not previously captured can be advantageous to performing up-to-date adherence-based monitoring, messaging, and benefits processing for a patient, having a complete or near complete view of the patient. The operations for retrieval of updated transaction information of this example method 600 can be performed at some later time after the receipt of the initial healthcare transaction 202. For example, when the patient visits a participating healthcare provider and receives an adherence message—perhaps one that indicates non-adherence—the patient may indicate a more recent fill or refill of the product than that previously captured in the stored data, for example, one which was filled at a non-participating pharmacy that does not typically transact with the service provider computer 104 for conventional transaction processing. In another example, the service provider computer 104 can receive update information for any monitored products that have previously been dispensed to the patient at or after the time of dispensing by the third party non-participating pharmacy (e.g., service provider requests, or the non-participating pharmacy transmits). Some or all of the below operations of the method 600 described with reference to FIG. 6 are performed by any suitable service provider computer and processing logic, such as the service provider computer 104 executing and the adherence monitoring and benefits module 106 described with reference to FIG. 1.

The method 600 begins at block 605, at some point in time after the service provider computer 104 stored transaction information for a healthcare transaction 202 for a monitored product and received a second healthcare transaction 210. At block 605 an adherence message 212 is transmitted by the service provider computer 104, as described in more detail with reference to block 540 of FIG. 5.

At block 610, the service provider receives an acknowledgment response that indicates that the patient has already received a new fill for the monitored product, of which the service provider was unaware. As described above, this may be due to the patient receiving the fill or refill from a non-participating pharmacy, in one example, or simply incomplete data at the service provider computer 104. This indication may be a response to a rejection transmitted in association with the operations of block 605, for example, or a separate message.

Upon receiving the indication at block 610, the service provider computer 104 proceeds to receive data with updated transaction information at block 615. According to one embodiment, this may be provided by the healthcare provider computer 102 to which the adherence message 212 was transmitted in block 605. According to other embodiments, the patient or another third party (e.g., the entity that filled or refilled the more recent transaction) can provide the updated transaction information associated with the prior fill or refill). The information provided by a third-party entity at block 615 may include a patient identifier, a product identifier, a days supply/quantity dispensed, and a date associated with the prior transaction.

Any number of means may be used to provide updated transaction information at block 615, including, but not limited to, providing a response to a healthcare transaction rejection over the network 110, transmitting data over the Internet, providing data using an interactive voice response unit, providing data via facsimile, providing data over email or Internet message, or any other means of electronically, or otherwise, integrating with a healthcare provider, a patient, and/or another third party entity (e.g., a non-participating pharmacy, etc.). The updated transaction information can be transmitted at the initiative of the third party, or in response to a request by the service provider.

Upon receiving the information from the third party entity at block 615, the service provider computer 104 can update the previously-stored transaction record associated with the patient/product at block 620. Updating can be performed in a manner similar to that described with reference to block 430 of FIG. 4 above. For example, update processing can include updating the previously stored days supply/quantity dispensed or next refill date and the date of the transaction with that received at block 615, or generating a new record creating an additional association between the patient, the product, the transaction date, and the days supply/quantity dispensed or next refill date. Thus, the previously stored transaction record can be updated with the updated transaction information or information derived (e.g., next refill date) from the updated transaction information.

Following block 620 is block 625, in which the service provider computer 104 continues any other processing of the second healthcare transaction 210. The method 600 ends after block 625.

The operations described and shown in the methods 300, 400, 500, and 600 of FIGS. 3-6 may be carried out or performed in any suitable order as desired in various embodiments. Additionally, in certain embodiments, at least a portion of the operations may be carried out in parallel. Furthermore, in certain embodiments, less than or more than the operations described in FIGS. 3-6 may be performed.

Likewise, while FIGS. 3-6 have been described primarily in conjunction with FIG. 2A, it will be appreciated that variations of FIG. 2A are available. As shown by FIG. 2B, the service provider computer 104 may be comprised of two or more distinct service provider computers 104a and 104b that are in communication with each other. The service provider computer 104a may be operative with the healthcare provider computer 102 while the service provider computer 104b may be operative with other healthcare provider computers and/or other third-party entity computers. However, the service provider computer 104b may have a data processing arrangement with the service provider computer 104a. Under the data processing arrangement, the service provider computer 104a may be permitted to utilize or offer services of the service provider computer 104b, including the operations of the adherence monitoring and benefits module 106. Accordingly, the services accessible by the service provider computer 104b, including the services of the adherence monitoring and benefits module 106, may be available to the healthcare provider computer 102 via the service provider computers 104a and 104b. Likewise, the service provider computer 104b can be configured to deliver a printing or facsimile request to the facsimile/printer device 180.

Various block and/or flow diagrams of systems, methods, apparatuses, and/or computer program products according to example embodiments of the invention are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method, comprising:
receiving, from a healthcare provider computer, a first healthcare transaction that identifies a product to be dispensed, and a patient for receiving the product, the first healthcare transaction associated with a first date;
determining that the product is associated with an adherence monitoring program, the adherence monitoring program indicating patient specifications for patient utilization of the product;
storing, based at least in part upon the determination that the patient is associated with an adherence monitoring program, an association between the patient, the product to be dispensed, and the first date associated with the first healthcare transaction;
receiving, from a healthcare provider computer, a second healthcare transaction that identifies the product to be dispensed, and the patient for receiving the product, the second healthcare transaction received subsequent to receiving the first healthcare transaction, the second healthcare transaction associated with a second date;
determining a level of adherence to the patient specifications of the adherence monitoring program by comparing at least the second date associated with the second healthcare transaction to the first date associated with the first healthcare transaction; and
delivering or directing a delivery of an adherence message that indicates the determined level of adherence to the patient specifications of the adherence monitoring program,
wherein the prior steps are performed by one or more service provider computer systems comprising one or more computers.

2. The computer-implemented method of claim 1, wherein the first and second healthcare transactions are respective billing requests associated with respective fills or refills of the product for the patient.

3. The computer-implemented method of claim 1, further comprising:
providing a financial benefit to the patient based upon the determined level of adherence to the patient specifications of the adherence monitoring program,
wherein the prior step is performed by one or more service provider computer systems comprising one or more computers.

4. The computer-implemented method of claim 3, further comprising:
providing the second healthcare transaction to claims processor computer for benefits adjudication, wherein the claims processor computer determines a patient responsibility amount in accordance with the benefits adjudication,
wherein the provided financial benefit alters the patient responsibility amount determined by the claims processor computer,
wherein the prior step is performed by one or more service provider computer systems comprising one or more computers.

5. The computer-implemented method of claim 4, further comprising:
delivering a response to the second healthcare transaction to the healthcare provider computer, wherein the response reflects an altered patient responsibility amount in accordance with the provided financial benefit,
wherein the prior step is performed by one or more service provider computer systems comprising one or more computers.

6. The computer-implemented method of claim 3, wherein the determined level of adherence indicates that the patient has filled or refilled the product within a desired time period in accordance with the patient specifications of the adherence monitoring program.

7. The computer-implemented method of claim 3, further comprising:
providing the first healthcare transaction to a claims processor computer for adjudication;
receiving an adjudication response for the first healthcare transaction from the claims processor computer, the adjudication response indicating whether the first healthcare transaction is approved or declined for benefits coverage,
wherein the storing of the association between the patient, the product to be dispensed, and the first date associated with the first healthcare transaction is further based upon the adjudication response indicating that the first healthcare transaction is approved for benefits coverage,
wherein the prior step is performed by one or more service provider computer systems comprising one or more computers.

8. The method of claim 3, wherein determining that the patient is associated with an adherence monitoring program comprises:
comparing the identity of the patient with stored data identifying a plurality of patients being monitored; and
determining the inclusion of the patient in the stored data identifying the plurality of patients.

9. The method of claim 1, wherein the adherence message is delivered to at least one of: (a) the healthcare provider computer; (b) a pharmacy; (c) a provider; or (d) the patient, via electronic, written, or audible communications.

10. The method of claim 1, wherein the adherence message is delivered (i) to a facsimile, (ii) to a printer, (iii) via email, (iv) via Internet message, or (v) via telephone call.

11. The method of claim 1, wherein the first date is a next refill date calculated based at least in part on the date of service for the first healthcare transaction.

12. The method of claim 11, wherein comparing at least the second date to the next refill date includes determining whether the second date is greater than or less than the next refill date, wherein if the second date is greater than the next refill date, then the level of adherence is determined to not be adherent, and wherein if the second date is less than the next refill date, then the level of adherence is determined to be adherent.

13. The method of claim 11, wherein the next refill date is further calculated based upon at least one of a days supply or a dispense quantity identified by the first healthcare transaction.

14. A system, comprising:
at least one memory operable to store computer-executable instructions; and
at least one processor configured to access the at least one memory and execute the computer-executable instructions to:
receive, from a healthcare provider computer, a first healthcare transaction that identifies a product to be dispensed, and a patient for receiving the product, the first healthcare transaction associated with a first date,
determine that the product is associated with an adherence monitoring program, the adherence monitoring program indicating patient specifications for patient utilization of the product,
store, based at least in part upon the determination that the patient is associated with an adherence monitoring program, an association between the patient, the product to be dispensed, and the first date associated with the first healthcare transaction,
receive, from a healthcare provider computer, a second healthcare transaction that identifies the product to be dispensed, and the patient for receiving the product, the second healthcare transaction received subsequent to receiving the first healthcare transaction, the second healthcare transaction associated with a second date,
determine a level of adherence to the patient specifications of the adherence monitoring program by comparing at least the second date associated with the second healthcare transaction to the first date associated with the first healthcare transaction, and
deliver or direct a delivery of an adherence message that indicates the determined level of adherence to the patient specifications of the adherence monitoring program.

15. The system of claim 14, wherein the first and second healthcare transactions are respective billing requests associated with respective fills or refills of the product for the patient.

16. The system of claim 14, wherein the at least one processor is further configured to execute the computer-executable instructions to provide a financial benefit to the patient based upon the determined level of adherence to the patient specifications of the adherence monitoring program.

17. The system of claim 16, wherein the at least one processor is further configured to execute the computer-executable instructions to:
provide the second healthcare transaction to claims processor computer for benefits adjudication, wherein the claims processor computer determines a patient responsibility amount in accordance with the benefits adjudication,
wherein the provided financial benefit alters the patient responsibility amount determined by the claims processor computer.

18. The system of claim 17, wherein the at least one processor is further configured to execute the computer-executable instructions to:
deliver a response to the second healthcare transaction to the healthcare provider computer, wherein the response reflects an altered patient responsibility amount in accordance with the provided financial benefit.

19. The system of claim 16, wherein the determined level of adherence indicates that the patient has filled or refilled the product within a desired time period in accordance with the patient specifications of the adherence monitoring program.

20. The system of claim 14, wherein the first date is a next refill date calculated based at least in part on at least one of a days supply or a dispense quantity identified by the first healthcare transaction.
